(19) United States
(12) Patent Application Publication
(10) Pub. No.: US 2026/0071033 A1
(43) Pub. Date: Mar. 12, 2026

(54) MANUFACTURING METHOD OF ENERGY RESPONSIVE COMPOSITION AND ENERGY RESPONSIVE COMPOSITION

(71) Applicant: CANON KABUSHIKI KAISHA, Tokyo (JP)

(72) Inventors: YUTAKA YOSHIMASA, Kanagawa (JP); YOSHIHIRO OHASHI, Tokyo (JP)

(21) Appl. No.: 19/392,689

(22) Filed: Nov. 18, 2025

Related U.S. Application Data
(63) Continuation of application No. PCT/JP2024/017348, filed on May 10, 2024.

(30) Foreign Application Priority Data
May 19, 2023 (JP) 2023-083371

(51) Int. Cl. C08J 3/21; C08K 3/105; C09K 11/66

(52) U.S. Cl. CPC C08J 3/212; C08K 3/105; C09K 11/665; C08J 2387/00; C08K 2201/011

(57) ABSTRACT

A method for manufacturing an energy responsive composition includes a step of preparing a polymer-containing solution that includes a solvent having a relative dielectric constant of a prescribed value or less and an associative polymer that has a main chain having a plurality of carbon atoms and a polar group having a higher polarity than the main chain and self-associates in the solvent, a step of preparing a mixture solution by bringing an energy-responsive nanoparticle into contact with the polymer-containing solution, and a step of extracting an energy responsive composition containing a plurality of energy responsive protective particles each including the nanoparticle and the associative polymer from the mixture solution by reducing the content of the solvent.

### CROSS-REFERENCE TO RELATED APPLICATIONS

This application is a Continuation of International Patent Application No. PCT/JP2024/017348, filed May 10, 2024, which claims the benefit of Japanese Patent Application No. 2023-083371, filed May 19, 2023, both of which are hereby incorporated by reference herein in their entirety.

### BACKGROUND

### Field of the Technology

The present disclosure relates to a manufacturing method of an energy responsive composition and an energy responsive composition.

### Description of the Related Art

It is known that a quantum dot having a perovskite-type crystal structure has a narrow full width at half maximum in the spectral sensitivity characteristics and exhibits a high color purity and is therefore applied to organic EL materials, quantum dot light-emitting materials, and solar battery materials. In addition, since the absorption and emission wavelengths can be controlled by the composition of halogens, the quantum dot has an advantage that it is easy to provide a material that responds to light over a wide wavelength range.

At the same time, it is known that a quantum dot having a perovskite-type crystal structure has low stability against external stimuli, such as light, heat, air, and moisture.

In particular, when quantum dots exist in a high density in the solid phase, the quantum dots tend to fuse together. If fusion occurs, the specific properties such as a quantum size effect are lost, and the desired physical properties are not expressed.

In Japanese Patent Laid-Open No. 2021-91870, stability is improved by protection from external stimuli by using a ligand including an organic acid salt and a polymer including an acidic group.

The quantum efficiency can be improved by using the technology described in Japanese Patent Laid-Open No. 2021-91870. However, when protection is performed by using a polymer as in the technology described in Japanese Patent Laid-Open No. 2021-91870, the distance between quantum dots cannot be decreased by the steric repulsion between the polymer chains. Consequently, the density of the quantum dot per unit volume decreases, and there is a problem of a decrease in characteristics such as the light emission amount.

### SUMMARY

The present invention has been made in view of the above problem and aims to provide a method for manufacturing an energy responsive composition that can densely arrange quantum dots even when a polymer is used as the ligand. In addition, the present invention aims to provide an energy responsive composition including a polymer and densely arranged quantum dots.

The method for manufacturing an energy responsive composition according to an embodiment of the present invention includes a step of preparing a polymer-containing solution that includes a solvent having a relative dielectric constant of a prescribed value or less and an associative polymer that includes a main chain having a plurality of carbon atoms and a polar group having a higher polarity than the main chain and self-associates in the solvent, a step of preparing a mixture solution by bringing an energy-responsive nanoparticle into contact with the polymer-containing solution (P), and a step of extracting an energy responsive composition containing a plurality of energy responsive protective particles each including the nanoparticle and the associative polymer from the mixture solution R by reducing the content of the solvent.

The energy responsive composition according to an embodiment of the present invention includes a plurality of energy responsive protective particles each including an energy-responsive nanoparticle and an associative polymer that has a main chain having a plurality of carbon atoms and a polar group having a higher polarity than the main chain, wherein a pair of adjacent energy responsive protective particles among the plurality of energy responsive protective particles is in contact with each other through the contact of the associative polymers thereof, and the nanoparticles of the adjacent energy responsive protective particles are spaced from each other.

Features of the present disclosure will become apparent from the following description of embodiments with reference to the attached drawings.

### BRIEF DESCRIPTION OF THE DRAWINGS

FIG. 1 is a flow chart of a method for manufacturing an energy responsive composition according to a first embodiment.

FIG. 2A is a diagram schematically illustrating a polymer-containing solution according to the first embodiment.

FIG. 2B is a diagram schematically illustrating the structure of a mixture solution according to the first embodiment.

FIG. 2C is a diagram schematically illustrating the structure of an energy responsive composition according to the first embodiment.

FIG. 3A is a diagram illustrating a form of the extracted energy responsive composition according to a second embodiment in a state supported by a supporting base material.

FIG. 3B is a diagram illustrating a form of the extracted energy responsive composition according to the second embodiment in a state supported by a supporting base material.

FIG. 3C is a diagram illustrating a form of the extracted energy responsive composition according to the second embodiment in a state supported by a supporting base material.

### DESCRIPTION OF THE EMBODIMENTS

Preferred embodiments of the present invention will now be described in detail using the drawings. The dimensions, materials, shapes, relative arrangements, and so on of the components described in these embodiments are not intended to limit the scope of this invention.

### First Embodiment

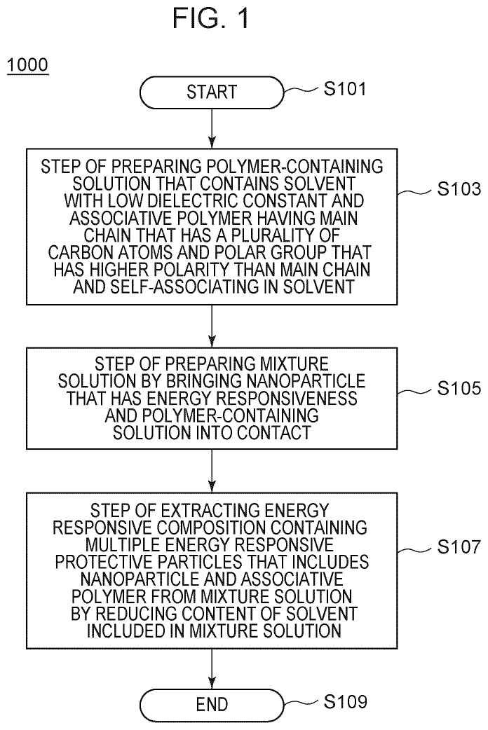

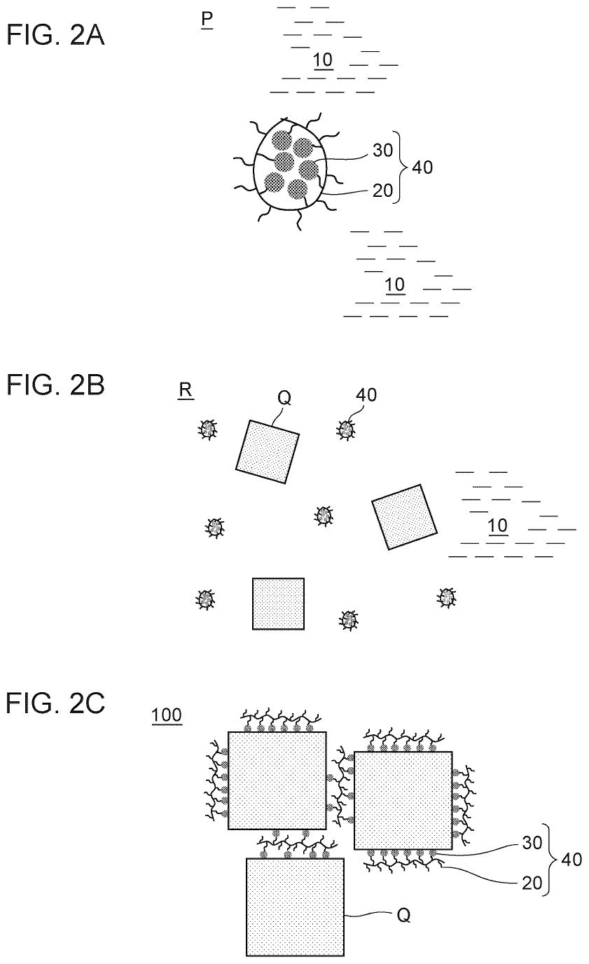

A manufacturing method of an energy responsive composition according to a first embodiment will be described using FIG. 1 and FIGS. 2A to 2C. FIG. 1 is a flow chart showing each step of the manufacturing method 1000 of an energy responsive composition according to the first embodiment. FIGS. 2A to 2C are diagrams schematically illustrating the configurations of a polymer-containing solution (FIG. 2A), a mixture solution (FIG. 2B), and an energy responsive composition (FIG. 2C) according to the first embodiment.

The manufacturing method 1000 of an energy responsive composition carries out each step of steps S101 to S109 as in FIG. 1.

### Step S103 of Preparing Polymer-Containing Solution

The step S103 of preparing a polymer-containing solution includes a step of preparing a polymer-containing solution (P) that contains a solvent 10 having a relative dielectric constant of a prescribed value or less and an associative polymer 40 that includes a main chain 20 having a plurality of carbon atoms and a polar group 30 having a higher polarity than the main chain 20 and self-associates in the solvent.

### Step S105 of Preparing Mixture Solution

The step S105 of preparing a mixture solution includes a step of preparing a mixture solution (R) by bringing an energy-responsive nanoparticle (Q) into contact with the polymer-containing solution (P).

### Step S107 of Extracting Energy Responsive Composition

The step S107 of extracting an energy responsive composition includes a step of extracting an energy responsive composition (S) containing a plurality of energy responsive protective particles each including a nanoparticle and an associative polymer from the mixture solution R by reducing the content of the solvent.

### Consideration of Effects

In the manufacturing method 1000 of the energy responsive composition 100 according to the present embodiment, although the detailed reasons for the above effects are not clear, the present inventors consider as follows.

The associative polymer 40 that includes a main chain 20 having a plurality of carbon atoms and a polar group 30 having a higher polarity than the main chain 20 and self-associates in the solvent 10 takes the form of a so-called unimer micelle in which polar groups 30 associate with each other in one polymer molecule under specific conditions (FIG. 2A). The unimer micelle has a small size of about several nanometers (an average particle size of the micelle is about 2 to 10 nm), and the polar group 30 is hidden inside. Therefore, even if the unimer micelle is mixed with the energy-responsive nanoparticle 60, coordination is difficult to proceed (FIG. 2B). When the content of the solvent 10 in the mixture solution (R) is decreased, firstly, the distance between nanoparticles 60 is decreased with an increase in the concentration. Secondly, the association is dissolved, and coordination proceeds while maintaining the short distance between the nanoparticles 60. On this occasion, since the coordination partially proceeds such that particles cross-link with each other, the distance between nanoparticles 60 is further difficult to increase (FIG. 2C).

### Self-Association

In the present embodiment, the self-association means intramolecular association by electrostatic interaction of at least a portion of polar groups 30 in the solvent 10 having a relative dielectric constant of a prescribed value or less. The polar groups 30 do not necessarily have to directly interact with each other, and a small amount of a polar material, such as water, may intervene therebetween. Furthermore, even when different types of polar groups associate with each other by electrostatic interaction, it is regarded as self-association.

### Nanoparticle

The energy-responsive nanoparticle Q in the present embodiment is preferably a nanoparticle that includes, as an allotrope, a nanocrystal having a perovskite-type crystal structure in which an A-site (monovalent cation), a B-site (divalent cation), and an X-site (monovalent anion including a halide anion) as structural components. The perovskite-type crystal structure is rephrased as a perovskite-type structure, an ABX₃-type crystal structure, or an ABX₃-type structure. In addition, a double perovskite-type crystal structure represented by A₂B₁B₂X₆ is also included in the perovskite-type crystal structure.

In the present specification, the energy-responsive nanoparticle Q may be rephrased as a nanoparticle, a light-emitting nanoparticle, a light-emitting nanocrystal, a photoresponsive nanocrystal, or a quantum dot.

The particle size of the nanoparticle is preferably 1 nm or more and 30 nm or less and more preferably 2 nm or more and 25 nm or less as the average particle size of the nanoparticle. If the average particle size is less than 1 nm, the stability may be insufficient. If the average particle size is larger than 30 nm, the dispersibility in a medium may be insufficient.

### A-Site of Perovskite-Type Structure

As the A-site, a monovalent cation is adopted. Examples of the monovalent cation used in the A-site include nitrogen-containing organic compound cations, such as an ammonium cation (NH₄⁺), an alkyl ammonium cation having 6 or less carbon atoms, a formamidinium cation (HC(NH₂)₂⁺), a guanidinium cation (C(NH₂)₃⁺), an imidazolium cation, a pyridinium cation, and a pyrrolidinium cation and include alkali metal cations, such as a lithium cation (Li⁺), a sodium cation (Na⁺), a potassium cation (K⁺), a rubidium cation (Rb⁺), and a cesium cation (Cs⁺).

These monovalent cations adopted in the A-site have small ion diameters and have sizes enough to fit into the crystal lattice, and therefore the perovskite compound can form a stable three-dimensional crystal.

Preferable examples of the alkyl ammonium cation having 6 or less carbon atoms include a methyl ammonium cation (CH₃NH₃⁺), an ethyl ammonium cation (C₂H₅NH₃⁺), and a propyl ammonium cation (C₃H₇NH₃⁺).

From the viewpoint of obtaining a high emission efficiency, at least any of a methyl ammonium cation, a formamidinium cation, and a cesium cation is preferably used as the A-site, and from the viewpoint of suppressing a change in the color, the A-site is more preferably a cesium cation. These monovalent cations may be used in the A-site in combination of two or more.

When the A-site is a cesium cation, a cesium salt is used as a raw material for synthesis of the nanoparticle. As the cesium salt, cesium chloride, cesium bromide, cesium iodide, cesium hydroxide, cesium carbonate, cesium hydrogen carbonate, cesium bicarbonate, cesium formate, cesium acetate, cesium propionate, cesium pivalate, or cesium oxalate is suitably used. An appropriate cesium salt among these cesium salt candidates can be used depending on the synthesis method.

When the A-site is another alkali metal cation, for example, a salt obtained by substituting the cesium element of the above-mentioned cesium compound with another alkali metal cation element can be used as a raw material.

When the A-site is a nitrogen-containing compound cation such as a methyl ammonium cation, for example, a neutral compound other than a salt, such as methylamine, can be used as a raw material. These raw materials may be used in combination of two or more.

Perovskite-type crystal structure B-site

As the B-site of the perovskite-type crystal structure, a divalent transition metal cation or a divalent cation including a typical divalent metal cation is adopted.

As the divalent transition metal cation, a scandium cation (Sc²⁺), a titanium cation (Ti²⁺), a vanadium cation (V²⁺), a chromium cation (Cr²⁺), a manganese cation (Mn²⁺), an iron cation (Fe²⁺), a cobalt cation (Co²⁺), a nickel cation (Ni²⁺), a copper cation (Cu²⁺), a palladium cation (Pd²⁺), a europium cation (Eu²⁺), or an ytterbium cation (Yb²⁺) is adopted.

As the typical divalent metal cation, a magnesium cation (Mg²⁺), a calcium cation (Ca²⁺), a strontium cation (Sr²⁺), a barium cation (Ba²⁺), a zinc cation (Zn²⁺), a cadmium cation (Cd²⁺), a germanium cation (Ge²⁺), a tin cation (Sn²⁺), or a lead cation (Pb²⁺) can be adopted.

Among these divalent cations, in terms of making a stable three-dimensional crystal grow, a typical divalent metal cation is preferable, and a tin cation or a lead cation is more preferable, and from the viewpoint of obtaining a high emission intensity, a lead cation is particularly preferable. These divalent cations may be used in combination of two or more, and the perovskite-type crystal structure may be a so-called double perovskite type.

When the B-site is a lead cation, a lead compound is used as a raw material for synthesis of the nanoparticle, an appropriate lead compound can be used depending on the synthesis method. As the lead compound, lead chloride, lead bromide, lead iodide, lead oxide, lead hydroxide, lead sulfide, lead carbonate, lead formate, lead acetate, lead 2-ethylhexanoate, lead oleate, lead stearate, lead naphthenate, lead citrate, lead maleate, or lead acetylacetonate is adopted. When the B-site is another divalent metal cation, a salt obtained by substituting the lead element of the above-mentioned lead compounds with another divalent metal cation element can be used as a raw material. These raw materials may be used in combination of two or more.

### X-Site of Perovskite-Type Crystal Structure

As the X of the perovskite-type crystal structure, a monovalent anion including a halide anion is adopted. Examples of the halide anion include a fluoride anion (F⁻), a chloride anion (Cl⁻), a bromide anion (Br⁻), and an iodide anion (I⁻). In particular, a chloride anion, a bromide anion, and an iodide anion are preferable from the viewpoint of forming a stable three-dimensional crystal and showing strong light emission in the visible light region. The emission color is blue when a chloride anion is used, green when a bromide anion is used, and red when an iodide anion is used.

Two or more types of halide anions may be used. In particular, when a chloride anion, a bromide anion, and an iodide anion are used in combination, the emission wavelength of the nanoparticle can be adjusted to a desired wavelength depending on the content ratio of the anion species. That is, in particular, a combination use of a chloride anion, a bromide anion, and an iodide anion is preferable because a light emission spectrum that covers almost all region of the visible light from blue to red can be obtained while maintaining a narrow full width at half maximum depending on the content ratio of the anion species.

The X-site may include a monovalent anion other than halide anions. Examples of the monovalent anion other than halide anions include pseudo-halide anions such as a cyanide anion (CN⁻), a thiocyanate anion (SCN⁻), and an isothiocyanate anion (CNS⁻).

The raw material for nanoparticle synthesis can be appropriately selected from a salt with counter cations at the A-site and the B-site, such as cesium chloride and lead bromide, and a salt with a cation other than the above depending on the synthesis method.

The nanoparticle Q in the present embodiment can be manufactured by a process as follows. For example, a hot injection method of obtaining a stable product by mixing a raw material solution at high temperature to generate a microparticle and then rapidly cooling it or a ligand-assisted reprecipitation method of obtaining a microparticle by reprecipitation utilizing a difference in the miscibility of the product with a solvent is adopted.

In addition, a room temperature synthesis method of obtaining a microparticle by mixing a mixture solution of a raw material for an A-site and a raw material for a B-site that are non-halides not containing a component for an X-site with a separately prepared raw material solution of an X-site under a moderate condition of around room temperature is also a manufacturing method to be adopted. Furthermore, a mechanochemical method of obtaining a product microparticle by reaction through mechanical mixing, such as milling, or ultrasonication of a solid raw material and an in situ synthesis method of obtaining a reaction product by applying a raw material solution onto a substrate and then performing direct crystal growth are also manufacturing methods to be adopted.

A ligand described later is coordinated to the surface of the nanoparticle Q by coexistence during manufacturing of the nanoparticle Q, and the dispersion can be stabilized. As needed, the surplus ligand may be removed by centrifugation or the like.

### Solvent

As the solvent, a solvent having a relative dielectric constant of a prescribed value or less can be used. The prescribed value is 6.0 or less and more preferably 4.5 or less.

Specifically, examples thereof include an aromatic hydrocarbon, such as xylene (relative dielectric constant: 2.3) and toluene (relative dielectric constant: 2.4); a hydrocarbon, such as hexane (relative dielectric constant: 1.9); an alicyclic hydrocarbon, such as cyclohexane (relative dielectric constant: 2.0); an ester, such as ethyl acetate (relative dielectric constant: 6.0) and butyl acetate (relative dielectric constant: 5.0); a halogenated alkyl, such as chloroform (relative dielectric constant: 4.9); and an ether, such as diethyl ether (relative dielectric constant: 4.3). As needed, these solvents can also be used as a mixture. In such a case, the relative dielectric constant is the weighted average of all solvents. In addition, the polymerizable compound described later can also be used as the solvent.

### Ligand

In the present embodiment, the ligand 30 is preferably at least one compound or ion selected from the group consisting of a weak acid such as carboxylic acid, a weak base such as amine, and salts and ions thereof.

Examples of the acid include branched or linear fatty acids having 1 to 30 carbon atoms. The alkyl chain may be saturated or unsaturated. In particular, from the viewpoint of solubility and stability to a solvent, a linear fatty acid is preferable, and oleic acid is further preferable.

Examples of the base include branched or linear organic bases having 1 to 30 carbon atoms. The alkyl chain may be saturated or unsaturated. In particular, from the viewpoint of solubility and stability to a solvent, a linear organic base is preferable, and oleylamine is further preferable.

The ligand may consist of a single ligand or a combination of two or more ligands.

### Amount of Ligand Relative to Nanoparticle Q

The amount of the ligand is preferably 10 or more and 500 or less when the nanoparticle Q is 100, more preferably 20 or more and 400 or less and further preferably 30 or more and 300 or less. When the amount of the ligand is less than 10 or greater than 300, the dispersion stability of the nanoparticle Q may be insufficient.

### Associative Polymer

In the present embodiment, the associative polymer 40 includes a main chain 20 having a plurality of carbon atoms and a polar group 30 having a higher polarity than the main chain 20, and includes an associative polymer that self-associates in a solvent 10.

The main chain 20 is the longest series of covalently bonded atoms and may include a side chain. The side chain is a linear, branched, or cyclic alkyl group, a linear, branched, or cyclic heteroalkyl group, an aryl group, a heteroaryl group, an aralkyl group, or a heteroaralkyl group. These compounds may be further partially substituted.

The polar group 30 is at least one selected from the group consisting of a strong acid such as sulfonic acid and phosphonic acid, a strong base such as a quaternary ammonium cation, a zwitterion group such as sulfobetaine, phosphobetaine, and carboxybetaine, and salts or ions thereof.

As the associative polymer, a copolymer (described later) obtained by polymerizing at least two types of monomers can be used.

### Amount of Associative Polymer Relative to Nanoparticle Q

The amount of the associative polymer is preferably 1 or more and 1000 or less when the nanoparticle Q is 100, more preferably 10 or more and 800 or less and further preferably 30 or more and 600 or less. When the amount of the associative polymer is less than 10, the effect of preventing fusion may not be sufficiently obtained. When the amount of the associative polymer is larger than 600, the unimer micelle may not be well formed in the solvent.

### Millimolar Number of Polar Group Per 1 g of Nanoparticle Q

The millimolar number of the polar group per 1 g of the nanoparticle Q is preferably 0.01 to 10, preferably 0.03 to 8, and more preferably 0.1 to 6. When the millimolar number of the polar group per 1 g of the nanoparticle Q is within the above range, the effect of preventing fusion is easily obtained. When the millimolar number is less than 0.01, fusion may not be effectively prevented. When the millimolar number is greater than 10, the unimer micelle may not be well formed in a low polar solvent. The millimolar number corresponds to the content of the polar group included in 1 g of the nanoparticle Q and is a unit corresponding to ×10⁻³ mol.

### Method for Manufacturing Energy Responsive Composition

The manufacturing method of the nanoparticle of the present invention will be described in detail below.

The manufacturing method of the present invention includes the following steps:
a step of preparing a polymer-containing solution (P) that contains a solvent 10 having a relative dielectric constant of a prescribed value or less and an associative polymer 40 that includes a main chain having a plurality of carbon atoms and a polar group 30 having a higher polarity than the main chain and self-associates in the solvent 10;
a step of preparing a mixture (C) by bringing an energy-responsive nanoparticle (Q) into contact with the polymer-containing solution (P); and
a step of extracting an energy responsive composition (S) containing a plurality of energy responsive protective particles each including the nanoparticle Q and the associative polymer 40 from the mixture C by reducing the content of the solvent 10.

### Step of Preparing Mixture (C)

The nanoparticle Q manufactured by the above-described method is brought into contact with a polymer-containing solution P obtained by dispersing the associative polymer 40 manufactured by the method described below in the solvent 10. The contact method may be a known method. As the contact method, for example, a method of mixing liquid phases of a dispersion of the nanoparticle Q and the polymer-containing solution P, a method of adding the polymer-containing solution P to a solid phase of the nanoparticle Q for redispersion and mixing is adopted. As another contact method, a method of applying the polymer-containing solution P to a solid phase of the nanoparticle Q on a support while rotating the support (spin coating) can be used. When the nanoparticle Q is dispersed in a liquid, the dispersion solvent may be the same as or different from the solvent of the polymer-containing solution P. The dispersion solvent of the nanoparticle Q preferably has a relative dielectric constant of a prescribed value or less. The prescribed value is preferably 6.0 or less and more preferably 4.5 or less.

The temperature for preparing the mixture C is preferably −80° C. or more and 50° C. or less and is preferably −30° C. or more and 40° C. or less. When the temperature is lower than −80° C., the contact between the nanoparticle and the associative polymer-containing solution cannot be made properly. When the temperature is higher than 50° C., the association of the associative polymer is dissolved, and coordination may proceed.

### Step of Extracting Energy Responsive Composition (S)

The energy responsive composition (S) containing a plurality of energy responsive protective particles each including the nanoparticle Q and the associative polymer 40 is extracted from the mixture C by reducing the content of the solvent. The method for reducing the content of the solvent is preferably a method by volatilizing the solvent under atmospheric pressure or a method by volatilizing the solvent under reduced pressure. On such an occasion, the mixture C is preferably applied onto the support.

The temperature for volatilizing the solvent is preferably −80° C. or more and 50° C. or less and is preferably −30° C. or more and 40° C. or less. When the temperature is lower than −80° C., the volatilization of the solvent may not efficiently proceed. When the temperature is higher than 50° C., the association of the associative polymer is dissolved, and coordination may proceed.

In the step of extracting an energy responsive composition, it is preferable that a pair of adjacent energy responsive protective particles among the plurality of energy responsive protective particles is in contact with each other through the contact of the associative polymers 40 thereof, and the nanoparticles of the adjacent energy responsive protective particles are spaced from each other.

The step of extracting the energy responsive composition preferably includes a step of removing the solvent 10.

After the step of extracting the energy responsive composition, as needed, a step of proceeding coordination of the associative polymer to the nanoparticle by heating may be performed.

### Manufacturing Method of Associative Polymer

A method for manufacturing a high molecular weight compound that can be used as the associative polymer 40 will be described in detail below. The method for manufacturing a high molecular compound is not particularly limited as long as the above-described structure is obtained, but the high molecular compound can be manufactured by, for example, the following method (i) or (ii).

That is, examples of the method (i) for manufacturing a high molecular compound include a manufacturing method by manufacturing a monomer having a structure unit including a polar group and then polymerizing the monomer. Examples of the method (ii) for manufacturing a high molecular compound include a method by synthesizing a polymer main chain and then bonding a polar group to the polymer main chain.

From the viewpoint of availability of a monomer and control of the amount of a functional group, manufacturing by the method (i) is preferable. A method for synthesizing a high molecular compound containing a zwitterion group as the polar group will be described in detail using the method (i) below.

As the monomer for introducing a polar group into a high molecular compound, a vinyl ether derivative, an acrylate derivative, a methacrylate derivative, an α-olefine derivative, an aromatic vinyl derivative, or the like can be used. From the viewpoint of ease of manufacturing of the monomer, it is preferable to use an acrylate derivative or s methacrylate derivative as the monomer.

The corresponding acrylate derivative or methacrylate derivative can be manufactured by, for example, the method described in the following literature: K. Ishihara and two others, “Polymer Journal”, (Japan), The society of Polymer Science, 1990, Vol. 22, pp. 355-360.

Examples of the method for polymerizing the above monomer include radical polymerization and ionic polymerization, and living polymerization for the purpose of molecular weight distribution control and structure control can also be used. Industrially, it is preferable to use radical polymerization.

The radical polymerization can be performed by the use of a radical polymerization initiator, light irradiation of radiation, laser light, and so on, combination use of a photopolymerization initiator and light irradiation, heating, or the like. The radical polymerization initiator may be one that can generate a radical and initiate polymerization and is selected from compounds that generate radicals by the action of heat, light, radiation, redox reaction, and so on.

Examples of the compound include an azo compound, an organic peroxide, an inorganic peroxide, an organic metal compound, and a photopolymerization initiator.

More specific examples include an azo compound, such as 2,2′-azobisisobutyronitrile (AIBN) and 2,2′-azobis(2,4-dimethylvaleronitrile); an organic peroxide, such as benzoyl peroxide (BPO), tert-butyl peroxypivalate, and tert-butylperoxy isopropyl carbonate; an inorganic peroxide, such as potassium persulfate and ammonium persulfate; and a redox initiator, such as a hydrogen peroxide-iron(II) salt system, a BPO-dimethylaniline system, and a cerium(IV) salt-alcohol system. Examples of the photopolymerization initiator include an acetophenone system, a benzoin ether system, and a ketal system. These radical polymerization initiators may be used in combination of two or more.

The preferable range of the polymerization temperature of the vinyl monomer varies depending of the type of the polymerization initiator to be used, and polymerization is usually performed at a temperature of −30° C. to 150° C., and more preferable temperature range is from 40° C. to 120° C.

The amount of the polymerization initiator to be used on this occasion is 0.1 parts by mass or more and 20 parts by mass or less based on 100 parts by mass of the monomer, and is preferably adjusted so as to obtain a high molecular compound with a target molecular weight distribution.

The polymerization method can be any of solution polymerization, suspension polymerization, emulsion polymerization, dispersion polymerization, precipitation polymerization, and bulk polymerization, and is not particularly limited.

The obtained high molecular compound may be purified as needed. The manufacturing method is not particularly limited, and a method such as reprecipitation, dialysis, column chromatography can be used.

The structure of the manufactured high molecular compound can be identified using various equipment analysis. As the analytical equipment, a nuclear magnetic resonance apparatus (NMR), a gel permeation chromatography (GPC), an inductively coupled plasma emission spectrometer (ICP-AES), and so on can be used.

### Polymerizable Compound

The polymerization of the polymerizable compound is promoted by receiving energy such as light and heat, and the compound becomes a component that imparts viscosity to the photoresponsive composition and cures it. As the polymerizable compound, a radical polymerizable compound or a cationic polymerizable compound can be used. These compounds may be used alone or in combination of two or more. Alternatively, a photopolymerizable compound or a thermopolymerizable compound can also be used. In the present specification, a form in which the viscosity is increased by polymerization of the polymerizable compound may be rephrased as a polymer.

As the radical polymerizable compound, for example, a monofunctional (meth)acrylate-based compound, a bifunctional (meth)acrylate-based compound, a tri- or more functional (meth)acrylate-based compound, a hydroxy group-containing (meth)acrylate-based compound, a carboxy group-containing (meth)acrylate-based compound, or a vinyl-based compound can be used.

As the monofunctional (meth)acrylate, for example, methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, cyclohexyl (meth)acrylate, dicyclopentenyl (meth)acrylate, dicyclopentenyloxyethyl (meth)acrylate, benzyl (meth)acrylate, 3,3,5-trimethylcyclohexyl acrylate, tetrahydrofurfuryl (meth)acrylate, phenoxyethyl (meth)acrylate, methoxyethyl (meth)acrylate, ethyl carbitol (meth)acrylate, isobornyl (meth)acrylate, methoxytriethylene glycol (meth)acrylate, (2-methyl-2-ethyl-1,3-dioxolan-4-yl)methyl (meth)acrylate, (3-ethyloxetan-3-yl)methyl (meth)acrylate, or cyclic trimethylolpropane formal (meth)acrylate can be used.

As the bifunctional (meth)acrylate-based compound, for example, 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, triethylene glycol di(meth)acrylate, tetraethylene glycol di(meth)acrylate, polyethylene glycol 200 di(meth)acrylate, polyethylene glycol 300 di(meth)acrylate, polyethylene glycol 400 di(meth)acrylate, polyethylene glycol 600 di(meth)acrylate, dipropylene glycol di(meth)acrylate, tripropylene glycol di(meth)acrylate, tetrapropylene glycol di(meth)acrylate, polypropylene glycol 400 di(meth)acrylate, polypropylene glycol 700 di(meth)acrylate, neopentyl glycol di(meth)acrylate, neopentyl glycol PO-modified di(meth)acrylate, EO-modified bisphenol A di(meth)acrylate, PO-modified bisphenol A di(meth)acrylate, or hydroxypivalic acid neopentyl glycol di(meth)acrylate can be used.

As the tri- or more functional (meth)acrylate-based compound, for example, trimethylolpropane tri(meth)acrylate, trimethylolpropane EO-modified tri(meth)acrylate, trimethylolpropane PO-modified tri(meth)acrylate, glycerin propoxy tri(meth)acrylate, pentaerythritol tri(meth)acrylate, tris(acryloxyethyl) isocyanurate, or EO-modified pentaerythritol tetraacrylate can be used.

As the vinyl-based compound, for example, vinyl acetate, vinyl benzoate, vinyl pivalate, vinyl butyrate, vinyl methacrylate, or N-vinyl pyrrolidone can be used.

As the cationic polymerizable compound, either a photopolymerizable or thermopolymerizable type can be used. These compounds may be used alone or in combination of two or more. Typical examples of the cationic polymerizable compound include an epoxy compound, an oxetane compound, and a vinyl ether compound.

The amount of the polymerizable compound, such as the radical polymerizable compound and the cationic polymerizable compound, to be used is preferably 1 to 99 parts by mass, more preferably 3 to 90 parts by mass, and further preferably 5 to 80 parts by mass based on 100 parts by mass of the total photoresponsive composition.

### Polymerization Initiator

In a polymerization reaction, a polymerization initiator and a polymerizable compound are usually used together. The polymerization initiator is a compound that generates an active species that initiates a polymerization reaction by active energy ray irradiation or heat, and a known polymerization initiator can be used. Main examples of the active species that initiates the polymerization reaction include a radical that is generated by a radical polymerization initiator and an acid that is generated by a cationic polymerization initiator, and they may be used in combination. Examples of the photoradical polymerization initiator that generates a radical by an active energy ray include acetophenones, such as diethoxyacetophenone, 2-hydroxy-2-methyl-1-phenylpropan-1-one, benzyl methyl ketal, 4-(2-hydroxyethoxy)phenyl-(2-hydroxy-2-propyl)ketone, 1-hydroxycyclohexylphenyl ketone, 2-methyl-1-[4-(methylthio)phenyl]-2-morpholinopropan-1-one, 2-benzyl-2-dimethylamino-1-(4-morpholinophenyl) butane, oligo[2-hydroxy-2-methyl-1-[4-(1-methylvinyl)phenyl]propanone], and 2-hydroxy-1-[4-[4-(2-hydroxy-2-methylpropionyl)benzyl]phenyl]-2-methylpropan-1-one; benzoins, such as benzoin, benzoin methyl ether, benzoin ethyl ether, benzoin isopropyl ether, and benzoin isobutyl ether; phosphines, such as 2,4,6-trimethylbenzoyl-diphenyl-phosphine oxide and bis(2,4,6-trimethylbenzoyl)-phenylphosphine oxide; and other examples such as methyl phenylglyoxylate.

Among the photoradical polymerization initiators, preferred are acetophenones represented by aminoketone, phosphines, and oxime ester compounds. They can be used alone or in combination depending on the properties desired for the cured product. The amount of the radical polymerization initiator to be used is preferably 0.01 to 100 parts by mass and more preferably 0.1 to 50 parts by mass based on 100 parts by mass of the total amount of the solid content in the composition.

### Other Additives

In the present embodiment, the energy responsive composition may be used, as needed, by mixing with an oxygen remover, an antioxidant, a scattering agent such as titanium oxide, a surfactant, an antifungal agent, a light stabilizer, other additives that impart various properties, a diluting solvent, and so on.

### Second Embodiment

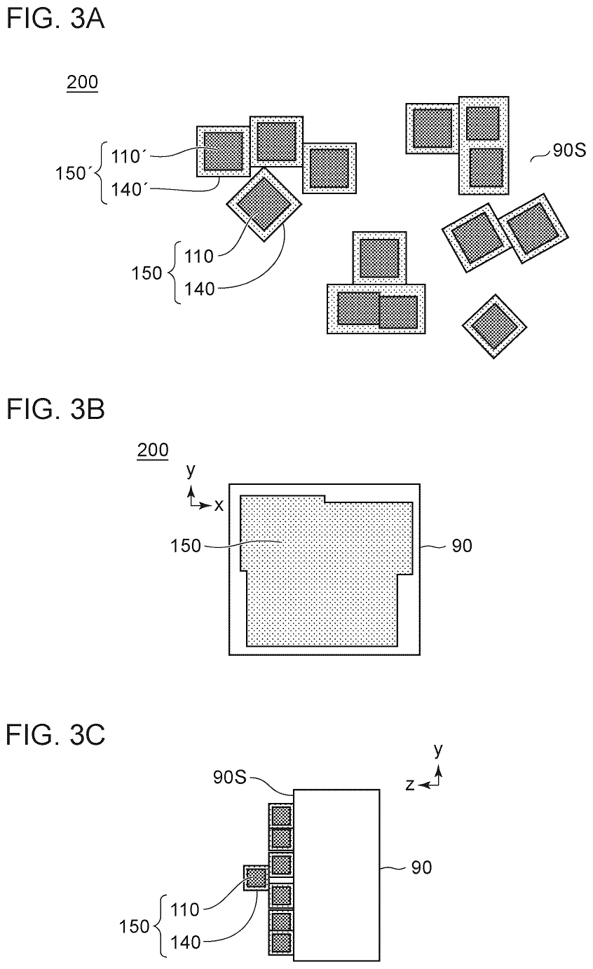

An energy responsive composition 100 according to a second embodiment will be described using FIGS. 3A to 3C.

FIGS. 3A to 3C each show a form of the extracted energy responsive composition 200 according to the present embodiment in a state supported by a base material 90 having a supporting surface 90S. FIGS. 3B and 3C are two-view diagrams showing the supporting state of the macroscopically viewed energy responsive composition 200. FIG. 3A is a microscopically enlarged partial view of FIG. 3B.

The energy responsive composition 100 includes a plurality of energy responsive protective particles 150. Each of the energy responsive protective particles 150 includes an energy-responsive nanoparticle 110 and an associative polymer 140 that includes a main chain 120 having a plurality of carbon atoms and a polar group 130 having a higher polarity than the main chain 120 and coordinates to the nanoparticle 110.

A pair of adjacent energy responsive protective particles (150, 150′) among the plurality of energy responsive protective particles is in contact with each other through the contact of the associative polymers (140, 140′) thereof, and the nanoparticles (110, 110′) of the adjacent energy responsive protective particles are spaced from each other.

### Nanoparticle

The nanoparticle 110 in the present embodiment is preferably a nanoparticle that includes, as an allotrope, a nanocrystal having a perovskite-type crystal structure in which an A-site (monovalent cation), a B-site (divalent cation), and an X-site (monovalent anion including a halide anion) are structural components. As the structural components, the same components as those of the nanoparticle Q described in the first embodiment can be used.

### Associative Polymer

In the present embodiment, the associative polymer 140 includes a main chain 120 having a plurality of carbon atoms and a polar group 130 having a higher polarity than the main chain 120. In addition, at least a portion of the associative polymer 140 preferably coordinates to the nanoparticle 110 so as to protect each of the nanoparticles Q.

The main chain 120 is the longest series of covalently bonded atoms and may include a side chain. The side chain is a linear, branched, or cyclic alkyl group, a linear, branched, or cyclic heteroalkyl group, an aryl group, a heteroaryl group, an aralkyl group, or a heteroaralkyl group. These compounds may be further partially substituted.

The polar group 130 is at least one selected from the group consisting of a strong acid such as sulfonic acid and phosphonic acid, a strong base such as a quaternary ammonium cation, a zwitterion group such as sulfobetaine, phosphobetaine, and carboxybetaine, and salts or ions thereof.

As the associative polymer 140, a copolymer obtained by polymerization of at least two types of monomers can be used. As the associative polymer 140, the same polymers as those of the associative polymer 40 shown in the first embodiment can be used.

### Third Embodiment

The energy responsive composition of the present invention can be applied to a quantum dot-containing wavelength conversion sheet (QD sheet), a quantum dot-containing wavelength conversion layer (QD-CC), and a quantum dot-containing electroluminescence (QD-EL) device.

Here, a QD-EL device applied with the energy responsive composition according to the present invention will be described.

The QD-EL device of the present invention includes, for example, electrodes (negative electrode and positive electrode), an electron injection/transport layer, a light-emitting layer, and a hole injection/transport layer. A surface treatment layer may be provided on any surface of the light-emitting layer.

### Electrode

The material of the electrode is not particularly limited. For example, materials that are used in organic electroluminescence (EL) devices and so on can be suitably used, and examples thereof include a transparent conductive oxide such as indium tin oxide (ITO), a metal such as Al, an alloy of Ag, Pd, and Cu (APC electrode), an alloy of Mg and Ag, and a layered product (layered electrode) in which a metal layer and a transparent conductive oxide layer such as ITO are layered. In the positive electrode and the negative electrode, the electrode on the side from which the light from the light-emitting layer is extracted is preferably transparent.

The thickness of the positive electrode is not particularly limited and can be, for example, 10 nm or more, 30 nm or more, or 50 nm or more and 1000 nm or less, 500 nm or less, or 200 nm or less. The thickness of the negative electrode is not particularly limited and can be, for example, 10 nm or more, 30 nm or more, or 50 nm or more and 1000 nm or less, 500 nm or less, or 200 nm or less.

### Hole Injection/Transport Layer

As the material of the hole injection/transport layer, for example, those that are used in organic EL devices can be suitably used. Examples of the organic material include polyvinylcarbazole (PVK), poly(9,9-dioctylfluorene-co-N-(4-butylphenyl)-diphenylamine) (TFB), poly(bis(4-phenyl)(2,4,6-trimethylphenyl)amine) (PTAA), poly[N,N′-bis(4-butylphenyl)-N,N′-bis(phenyl)-benzidine](poly-TPD), and poly(3,4-ethylenedioxythiophene) poly(styrenesulfonate) (PEDOT:PSS). Examples of the inorganic material include NiO, TiO₂, and MoOₓ. These materials may be used alone or in combination of two or more.

The hole injection/transport layer may have a monolayer structure or have a layered structure. The layered structure can include a hole injection layer that is arranged on the positive electrode side and a hole transport layer that is arranged on the light-emitting layer side.

The thickness of the hole injection/transport layer in the monolayer structure is appropriately adjusted considering the influence on the hole injection and transport properties and optical characteristics. For example, the lower limits of the thicknesses of the hole injection layer and the hole transport layer may be 10 nm and 20 nm, respectively, and the upper limits of the thicknesses of the hole injection layer and the hole transport layer may be 1000 nm and 500 nm, respectively.

### Light-Emitting Layer

The energy responsive composition according to the present invention can be used as a light-emitting layer.

The thickness of the light-emitting layer is not particularly limited and can be, for example, 10 nm or more, 50 nm or more, or 75 nm or more and 1000 nm or less, 500 nm or less, or 250 nm or less.

### Electron Injection/Transport Layer

As the material of the electron injection/transport layer, for example, those that are used in organic EL devices can be suitably used. Examples of the organic material include LiF, 1,3,5-tris(1-phenyl-1H-benzimidazol-2-yl)benzene (TPBi), N,N′-di-1-naphthyl-N,N′-diphenylbenzidine (NPD), 4,4′-bis(N-carbazolyl)-1,1′-biphenyl (CBP), and 4,6-bis(3,5-di(pyridin-3-yl)phenyl)-2-methylpyrimidine (B₃PyMPM). Examples of the inorganic material include a-ZSO (amorphous zinc silicate; Zn—Si—O), ZnO, and SnO. These materials may be used alone or in combination of two or more.

The electron injection/transport layer may have a monolayer structure or have a layered structure. The layered structure can include an electron injection layer that is arranged on the negative electrode side and an electron transport layer that is arranged on the light-emitting layer side.

The thickness of the electron injection/transport layer in the monolayer structure is not particularly limited and is appropriately adjusted considering the influence on the electron injection and transport properties and optical characteristics. For example, the lower limits of the thicknesses of the electron injection layer and the electron transport layer are 1 nm and 10 nm, respectively. The upper limits of the thicknesses of the electron injection layer and the electron transport layer are 1000 nm and 500 nm, respectively.

In the above explanation, a bottom emission type in which the light emitting device extracts light from the positive electrode side (substrate side) has been mainly described, but the light emitting device is not limited thereto. For example, the light emitting device may be a top emission type in which light is extracted from the negative electrode side (opposite side of substrate).

### Measurement Method

Various physical properties can be measured as follows.

### Array Density

The array density of the energy responsive composition can be measured with a transmission electron microscope (TEM) or a scanning electron microscope (SEM) when observation from a vertical direction is possible, and can be measured using a cross-sectional SEM image when observation from a vertical direction with respect to the energy responsive composition is impossible. The array density can be evaluated using, for example, the average surface-to-surface distance between particles and the particle occupancy rate per unit area in the image. The average surface-to-surface distance between particles can be determined by selecting, for example, 100 particles by image processing software and measuring the shortest distances between each of particles and averaging them.

Alternatively, a relative array density can also be calculated from the amount of light absorbed or emitted per unit volume of the film. Since the amount of emitted light varies depending on the photoluminescence quantum yield (PLQY), the array density is preferably calculated from the amount of absorbed light.

### Stability Evaluation

The stability of the energy responsive composition can be evaluated by, for example, evaluating the PLQY or the fusion rate between nanoparticles observed with a TEM.

### Measurement of Molecular Weight Distribution

The molecular weight distribution of the associative polymer can be calculated by gel permeation chromatography (GPC) in terms of monodisperse polymethyl methacrylate. The measurement of the molecular weight by GPC can be performed, for example, as follows.

A sample is added to an eluent described below so as to give a sample concentration of 1 mass %, the mixture is left to stand at room temperature for 24 hours to prepare a solution, and the solution is filtered through a solvent-resistant membrane filter with a pore diameter of 0.45 μm to obtain a sample solution, which is subjected to measurement under the following conditions:
Apparatus: Agilent 1260 infinity system (manufactured by Agilent Technologies, Inc.);
Column: PFG analytical linear M columns (manufactured by Precision System Science Co., Ltd.);
Eluent: 2,2,2-trifluoroethanol;
Flow rate: 0.2 mL/min;
Oven temperature: 40° C.; and
Sample injection volume: 20 μL.

In the calculation of the molecular weight distribution of a sample, a molecular weight calibration curve produced by using a standard polymethyl methacrylate resin (manufactured by Agilent Technologies, Inc., EasiVial PM polymer standard kit) is used.

### Structure Analysis of Associative Polymer

The structure analysis of an associative polymer can be performed using nuclear magnetic resonance (NMR). For example, spectra of ¹H-NMR and ¹³C-NMR are measured using ECA-600 (600 MHz) manufactured by JEOL Ltd. On that occasion, the measurement is performed at 25° C. in a deuteration solvent including tetramethylsilane as an internal standard material. The chemical shift value is read as a ppm shift value (6 value) with tetramethylsilane as the internal standard material set as 0.

### Verification Method of Coordination of Associative Polymer to Nanoparticle

Whether the associative polymer 40 is coordinated to the nanoparticle Q or not can be verified using nuclear magnetic resonance (NMR). For example, ¹H-NMR is measured using ECA-600 (600 MHz) manufactured by JEOL Ltd. Coordination can be confirmed by a shift of the δ value of the ¹H signal in the betaine structure from the δ value of the associative polymer alone or a change of the half width.

### Analysis of Association State of Associative Polymer

The association state of an associative polymer can be analyzed using NMR or dynamic light scattering (DLS). When NMR is used, for example, ¹H-NMR is measured using ECA-600 (600 MHz) manufactured by JEOL Ltd. When the polymer is associated, the chemical shift value of the signal of the polar group changes from the value in the unassociated state. In addition, when the polymer is associated, since the molecular movement is restricted, a spectrum that is broader overall is observed. As needed, it is also possible to analyze the association state in more detail by relaxation time measurement. When DLS is used, the association state can be analyzed from the particle diameter. When the associative polymer associates intramolecularly, a particle diameter of an approximately several nanometers is observed.

### Analysis of Crystal Structure (Crystalline Phase) of Nanoparticle

Crystal structure (crystalline phase) analysis and composition analysis of a nanoparticle can be performed using X-ray diffraction (XRD). For example, crystal structure and composition can be analyzed by measuring the X-ray diffraction pattern using RINT 2100 (manufactured by Rigaku Corporation) and comparing it with the diffraction pattern on a database. Depending on the form and size of the analysis specimen, electron beam diffraction (ED) accompanied cross-sectional TEM may be used.

### Composition Analysis of Nanoparticle

The composition of a nanoparticle can also be analyzed using XPS and ICP emission spectral analysis. The molar ratio of A and B can be measured from the signal strength of XPS, and the concentration of X can be measured from the emission intensity in ICP emission spectral analysis (e.g., CIROS CCD (manufactured by SPECTRO GmbH)).

### Amounts of Ligand and Associative Polymer to Nanoparticle

The amounts of a ligand and an associative polymer relative to the amount of the nanoparticle can be determined by TG-DTA measurement and NMR measurement. For example, the amount of the nanoparticle in an energy responsive composition is measured by TG-DTA measurement. Subsequently, the amount of the ligand and the amount of the associative polymer in the energy responsive composition are respectively determined by NMR measurement, and thereby the amounts of the ligand and the associative polymer relative to the nanoparticle can be determined.

### Amount of Polar Group in Associative Polymer

The amount of a polar group in an associative polymer can be determined by NMR measurement. For example, ¹H-NMR is measured using ECA-600 (600 MHz) manufactured by JEOL Ltd. The amount of the polar group in the associative polymer is calculated by comparing the signal strength derived from the polar group and the signal strength derived from the portion other than the polar group.

### Millimolar Number of Polar Group Per 1 g of Nanoparticle

The millimolar number of the polar group per 1 g of the nanoparticle can be calculated from the amount of the nanoparticle, the amount of the associative polymer, and the amount of the polar group in the associative polymer determined by the above methods.

### EXAMPLES

The present disclosure will be described in more detail by Examples below, but the present disclosure is not limited thereby.

### Manufacturing of Associative Polymer a

A reaction vessel equipped with a condenser tube, a stirrer, a thermometer, and a nitrogen inlet tube was provided. The reaction vessel was charged with 3-[[2-(methacryloyloxy)ethyl]dimethylammonio]propane-1-sulfonate (5.9 parts), hexyl methacrylate (48.0 parts), azobisisobutyronitrile (3.9 parts), and 2,2,2-trifluoroethanol (900 parts). Furthermore, the reaction vessel was subjected to nitrogen bubbling for 30 minutes. The resulting reaction mixture was heated at 65° C. for 8 hours under a nitrogen atmosphere to complete the polymerization reaction. The reaction solution was cooled to room temperature, and water (300 parts) was then added thereto to precipitate the product. After centrifugation, the supernatant was removed. The solvent was distilled off under reduced pressure, followed by drying at 50° C. under a reduced pressure of 0.1 kPa or less to obtain an associative polymer a. It was confirmed by NMR measurement that the structure unit including the polar group was contained in an amount of 7 mol % of the total monomer units. The weight-average molecular weight (Mw) by GPC analysis was 13200.

### Manufacturing of Associative Polymer b

An associative polymer b was manufactured as in the manufacturing of the associative polymer a except that the amounts of 3-[[2-(methacryloyloxy)ethyl]dimethylammonio]propane-1-sulfonate and hexyl methacrylate in the manufacturing of the associative polymer a were changed from 5.9 parts to 15.2 parts and from 48.0 parts to 42.3 parts, respectively.

Table 1 shows the structures, compositions, and molecular weights of the manufactured associative polymers a and b.

TABLE 1

| Asso- | | | Molec- |
|---|---|---|---|
| ciative | | | ular |
| polymer | Structure | m:n | weight |
| a | 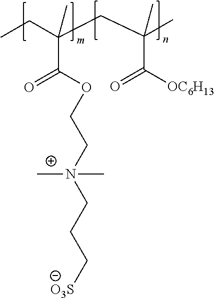 | 7:93 | 13200 |
| b | 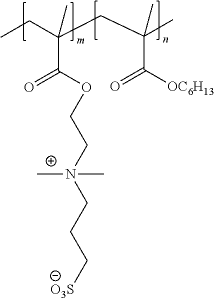 | 18:82 | 13500 |

### Preparation of Associative Polymer-Containing Solution

### Associated Solution a of Associative Polymer a in Toluene

A reaction vessel equipped with a stirrer, a thermometer, and a reflux condenser was charged with the associative polymer a (0.8 parts) and toluene (99.2 parts), and the temperature thereof was increased to 80° C., and the temperature was maintained for 5 minutes. After confirmation that the associative polymer a was completely dissolved, the solution was quickly cooled to room temperature to obtain an associated solution a of the associative polymer a in toluene. It was confirmed by DLS measurement that a unimer micelle with a particle diameter of 5 nm was generated.

### Associated Solution b-1 of Associative Polymer b in Toluene

An associated solution b-1 of the associative polymer b in toluene was prepared as in the associated solution a of associative polymer a in toluene except that the associative polymer b was used instead of the associative polymer a. It was confirmed by DLS measurement that a unimer micelle with a particle diameter of 4 nm was generated.

### Associated Solution b-2 of Associative Polymer b in Chloroform

A reaction vessel equipped with a stirrer, a thermometer, and a reflux condenser was charged with the associative polymer b (0.8 parts) and chloroform (99.2 parts), and the temperature thereof was increased to 60° C., and the temperature was maintained for 5 minutes. The mixture was quickly cooled to room temperature to obtain an associated solution b-2 of the associative polymer b in chloroform.

### Manufacturing of Nanoparticle Q-1

Cesium carbonate (10 parts), oleic acid (27 parts), and 1-octadecene (385 parts) were placed in a flask, and the solution temperature was increased to 120° C., followed by deaeration with a vacuum pump for 30 minutes. Furthermore, the solution temperature was increased to 150° C. under a dry nitrogen gas flow, and the temperature was maintained for 30 minutes to obtain a cation raw material solution.

Separately, lead(II) bromide (10 parts) and 1-octadecene (494 parts) were placed in a flask, and the solution temperature was increased to 120° C., followed by deaeration with a vacuum pump for 1 hour. Oleic acid (89 parts) and oleylamine (31 parts) were added thereto, followed by further deaeration with a vacuum pump for 30 minutes. Then, the solution temperature was set to 185° C. instead of the nitrogen flow.

The cation raw material solution (40 parts) was added thereto, and after 5 seconds, the mixture was cooled on ice. Ethyl acetate (2000 parts) was added thereto, centrifugation was performed, and the supernatant was removed. The resulting residue was dispersed in toluene, and the solid concentration was adjusted to 1 wt % to obtain a dispersion of a nanoparticle Q-1 having a perovskite-type crystal structure of CsPbBr₃. The ratio of the nanoparticle Q in the solid content measured by TG-DTA was 53 wt %.

### Manufacturing of Nanoparticle Q-2

A dispersion of the nanoparticle Q-2 having a perovskite-type crystal structure of CsPb(Br/I)₃ was obtained as in the light-emitting nanocrystal dispersion a except that lead(II) bromide (3.2 parts) and lead(II) iodide (9.3 parts) were used instead of lead(II) bromide (10 parts). The ratio of the nanoparticle Q in the solid content measured by TG-DTA was 52 wt %.

### Example 1

The dispersion a (100 parts) of the nanoparticle Q-1 was placed in a container, and the solvent was distilled off under reduced pressure. The associated solution a (100 parts) of the associative polymer a in toluene was added thereto for redispersion. The dispersion was spin-coated at 1000 rpm for 20 seconds on a glass substrate of 2 cm×2 cm washed with UV-O₃ to obtain an energy responsive composition 100-1.

### Examples 2 to 4 and Comparative Example 2

Energy responsive compositions 100-2 to 4 and 6 were obtained as in EXAMPLE 1 except that the types of the nanoparticle Q, the associative polymer, and the associated solution were changed to those shown in Table 2.

### Comparative Example 1

The dispersion a (100 parts) of the nanoparticle Q-1 was placed in a container, and the solvent was distilled off under reduced pressure. The associated solution a (100 parts) of the associative polymer a in toluene was added thereto for redispersion, and the dispersion was heated at 50° C. for 20 minutes to complete the coordination. The dispersion was spin-coated at 1000 rpm for 20 seconds on a glass substrate of 2 cm×2 cm washed with UV-O₃ to obtain an energy responsive composition 100-5.

TABLE 2
Table 2

| | Energy | | | | | |
|---|---|---|---|---|---|---|
| | responsive | | | Millimolar number of | | |
| | composition | Nanoparticle | Associative | polar group per 1 g of | Associated | |
| | 100-i | B | polymer | nanoparticle A | solution | Heating |
| Example 1 | Energy | Nanoparticle | Associative | 0.6 | Associated | Without |
| | responsive | B-1 | polymer a | | solution a | |
| | composition | | | | | |
| | 100-1 | | | | | |
| Example 2 | Energy | Nanoparticle | Associative | 1.5 | Associated | Without |
| | responsive | B-1 | polymer b | | solution b-1 | |
| | composition | | | | | |
| | 100-2 | | | | | |
| Example 3 | Energy | Nanoparticle | Associative | 1.5 | Associated | Without |
| | responsive | B-1 | polymer b | | solution b-2 | |
| | composition | | | | | |
| | 100-3 | | | | | |
| Example 4 | Energy | Nanoparticle | Associative | 1.5 | Associated | Without |
| | responsive | B-2 | polymer b | | solution b-1 | |
| | composition | | | | | |
| | 100-4 | | | | | |
| Comparative | Energy | Nanoparticle | Associative | 1.5 | Associated | With |
| Example 1 | responsive | B-1 | polymer b | | solution b-1 | |
| | composition | | | | | |
| | 100-5 | | | | | |
| Comparative | Energy | Nanoparticle | — | — | Toluene | Without |
| Example 2 | responsive | B-1 | | | | |
| | composition | | | | | |
| | 100-6 | | | | | |

### Evaluation

### Density Evaluation 1 of Nanoparticle

The densities of the nanoparticles were evaluated by the amounts of light absorbed by the energy responsive compositions 100-1 to 6.

The measurement conditions and evaluation criteria are shown below.

### Measurement Conditions:

Measurement apparatus: absolute PL quantum yield measurement apparatus C9920-03 (manufactured by Hamamatsu Photonics K.K.);
Excitation light wavelength: 460 nm; and
Excitation light integral range: excitation light wavelength±10 nm.

### Evaluation Criteria:

A: an amount of absorbed light of 6×10⁶ or more;
B: an amount of absorbed light of 4×10⁶ or more and less than 6×10⁶; and
C: an amount of absorbed light of less than 4×10⁶.

Table 3 shows the evaluation results.

### Stability Evaluation 1

Each sample was left to stand in the air for 7 days, and the PLQY was then measured to evaluate the stability.

The measurement conditions and evaluation criteria are shown below.

### Measurement Conditions:

Measurement apparatus: absolute PL quantum yield measurement apparatus C9920-03 (manufactured by Hamamatsu Photonics K.K.);
Excitation light wavelength: 460 nm;
Excitation light integral range: excitation light wavelength±10 nm; and
Emission light integral range: (excitation light wavelength±20) nm to 770 nm.
Evaluation criteria:
A: a PLQY of 70% or more;
B: a PLQY of greater than 50% and less than 70%; and
C: a PLQY of 50% or less.

Table 3 shows the evaluation results.

### Density Evaluation 2 of Nanoparticle

Each of the energy responsive compositions 100-1 to 6 was diluted 20 times, and 3 μL thereof was added onto a support film (high-resolution carbon HRC-C10). The solvent was volatilized at ordinary temperature, and TEM observation was performed with Technai F30 (manufactured by FEI Company). The average surface-to-surface distance between particles was calculated for 100 particles selected from a TEM image, and the density of the nanoparticles was evaluated by the following criteria:
A: an average surface-to-surface distance of 5 nm or less;
B: an average surface-to-surface distance of greater than 5 nm and 15 nm or less; and
C: an average surface-to-surface distance of greater than 15 nm.

Table 3 shows the evaluation results.

Stability evaluation 2

In the above TEM image, 100 particles were selected, and the stability of the nanoparticles was evaluated by the following criteria:
A: fusion was observed in 5 or less particles;
B: fusion was observed in more than 5 and 10 or less particles; and
C: fusion was observed in more than 10 particles.

Table 3 shows the evaluation results.

TABLE 3

| | | Nanopar- | | Nanopar- | |
|---|---|---|---|---|---|
| | Energy | ticle | | ticle | |
| | responsive | density | Stability | density | Stability |
| | composition | evaluation | evaluation | evaluation | evaluation |
| | 100-i | 1 | 1 | 2 | 2 |
| Example 1 | Energy | A | B | A | B |
| | responsive | | | | |
| | composition | | | | |
| | 100-1 | | | | |
| Example 2 | Energy | A | A | A | A |
| | responsive | | | | |
| | composition | | | | |
| | 100-2 | | | | |
| Example 3 | Energy | B | B | B | B |
| | responsive | | | | |
| | composition | | | | |
| | 100-3 | | | | |
| Example 4 | Energy | A | A | A | A |
| | responsive | | | | |
| | composition | | | | |
| | 100-4 | | | | |
| Compar- | Energy | C | A | C | A |
| ative | responsive | | | | |
| Example 1 | composition | | | | |
| | 100-5 | | | | |
| Compar- | Energy | A | C | A | C |
| ative | responsive | | | | |
| Example 2 | composition | | | | |
| | 100-6 | | | | |

According to Table 3, the energy responsive compositions 100-1 to 4 according to EXAMPLES 1 to 4 had high nanoparticle densities and high stability. In contrast, the energy responsive composition 100-5 according to COMPARATIVE EXAMPLE 1 had high stability, but the density of the nanoparticle was low. The energy responsive composition 100-6 according to COMPARATIVE EXAMPLE 2 had a high nanoparticle density, but the stability was low.

These results demonstrate that an associative polymer forms a unimer micelle in a low polar solvent and thereby does not coordinate in the dispersed state, nanoparticles are densely arranged during film formation, and then coordination proceeds.

The present invention is not limited to the above embodiments, and various modifications and variations can be made without departing from the spirit and scope of the present invention. Accordingly, to apprise the public of the scope of the present invention, the following claims are appended.

According to the present invention, it is possible to provide a method for manufacturing an energy responsive composition that can densely arrange quantum dots even when a polymer is used as the ligand. In addition, it is possible to provide an energy responsive composition that includes a polymer and densely arranged quantum dots.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A method for manufacturing an energy responsive composition, comprising:
a step of preparing a polymer-containing solution that includes a solvent having a relative dielectric constant of a prescribed value or less and an associative polymer that has a main chain having a plurality of carbon atoms and a polar group having a higher polarity than the main chain and self-associates in the solvent;
a step of preparing a mixture solution by bringing an energy-responsive nanoparticle into contact with the polymer-containing solution; and
a step of extracting an energy responsive composition containing a plurality of energy responsive protective particles each including the nanoparticle and the associative polymer from the mixture solution by reducing the content of the solvent.

2. The method for manufacturing an energy responsive composition according to claim 1, wherein in the step of extracting an energy responsive composition, a pair of adjacent energy responsive protective particles among the plurality of energy responsive protective particles is in contact with each other through the contact of the associative polymers thereof, and the nanoparticles of the adjacent energy responsive protective particles are spaced from each other.

3. The method for manufacturing an energy responsive composition according to claim 1, wherein the step of extracting an energy responsive composition includes a step of removing the solvent.

4. The method for manufacturing an energy responsive composition according to claim 1, wherein the nanoparticle has a perovskite-type crystal structure.

5. An energy responsive composition comprising:
a plurality of energy responsive protective particles each including:
an energy-responsive nanoparticle; and
an associative polymer that includes a main chain having a plurality of carbon atoms and a polar group having a higher polarity than the main chain and coordinates to the nanoparticle, wherein
a pair of adjacent energy responsive protective particles among the plurality of energy responsive protective particles is in contact with each other through the contact of the associative polymers thereof, and the nanoparticles of the adjacent energy responsive protective particles are spaced from each other.

6. The energy responsive composition according to claim 5, wherein the nanoparticle has a perovskite-type crystal structure.

7. The energy responsive composition according to claim 5, wherein the polar group coordinates to the nanoparticle so as to protect each nanoparticle.

8. The energy responsive composition according to claim 5, wherein the plurality of energy responsive protective particles are supported by a base material having a supporting surface.
